(19) United States
(12) Patent Application Publication
(10) Pub. No.: US 2013/0281117 A1
(43) Pub. Date: Oct. 24, 2013

(54) SYSTEM AND METHOD FOR INDOOR POSITIONING OF MOBILE TERMINALS

(71) Applicants: Aimin Shen, Shenzhen Guangdong (CN); Meixiang Li, Shenzhen Guangdong (CN)

(72) Inventors: Aimin Shen, Shenzhen Guangdong (CN); Meixiang Li, Shenzhen Guangdong (CN)

(21) Appl. No.: 13/976,692

(22) PCT Filed: Dec. 30, 2011
(86) PCT No.: PCT/CN2011/084985

§ 371 Date: Jun. 27, 2013

(30) Foreign Application Priority Data
Dec. 31, 2010 (CN) 201010619700.0

(51) Int. Cl. H04W 64/00

(52) U.S. Cl. CPC H04W 64/003
USPC 455/456.1

(57) ABSTRACT

This invention discloses a system and method for indoor positioning of a mobile terminal. The system comprises a control end and at least one positioning node installed indoors. The at least one positioning node, under the control of the control end, transmits linkage information to the mobile terminal within a specific zone, receives response information responded by the mobile terminal, measures signal strength of the response information, and transmits the received response and signal strength information to the control end. The control end analyzes and calculates on the received response and signal strength information to locate the mobile terminal. Using this invention, a user can realize accurate positioning of an indoor mobile terminal without changing existing mobile terminals. The disclosed positioning system and method is simple and convenient for use and has extensive applicability.

### TECHNICAL FIELD

This invention relates to the mobile communication technical field, especially to a system and method for indoor positioning/locating of mobile terminals.

### TECHNICAL BACKGROUND

With the massive popularity of mobile communications and mobile multimedia applications, portable terminal equipment with the mobile communications and multimedia playback functions gradually becomes requisite objects carried by people in their daily lives. A “Radio-Frequency IC card device with very high frequency” (Chinese Application No. 200710124354.7) discloses a 2.4 GHz radio-frequency (“RF”) integrated-circuit (“IC”) card devices used in mobile terminal equipment and its realization methods. A typical application of such 2.4 GHz RF IC card device is to install the RF IC card device in a cell phone and to control the 2.4 GHz RF communication distance within a certain range, thereby realizing a short-distance cell phone card-swiping function. Since this kind of 2.4 GHz RF IC card devices can change people's daily payment methods and provide convenience to people's living, it will surely become popular to a very large extend.

In recent years, as people's demands for a location based information service (LBS, Location Based Service) increase, LBS has obtained extensive attention. To locate a person quickly and accurately in an indoor background, such as a shopping mall, an entertainment place, a supermarket, and a parking lot, has very positive meaning for guiding the shopping route, directing the parking, delivering business information in a specific zone, etc.

Conventional methods for positioning/locating a mobile terminal mainly include GPS, GSM base station, Zigbee positioning, etc. As the GPS positioning mode is largely influenced by building-structure shielding, weather factors, and satellite signal interferences, it is not used preferably indoors or in a relatively enclosed environment. The GSM positioning mode is based on the cellular mobile communication mode. Its positioning accuracy is low, normally above 50 meters. Moreover, its uplink-and-downlink communications are also subjected to the influence of the shielding effect of building structures. Especially in a large indoor environment with centralized stream of people, the communication conditions are severe and the positioning function can hardly be realized. The Zigbee positioning mode is mainly used on an industrial site for short-distance networking and communication control. The Zigbee modules do not exist popularly in mobile terminals that are used by people daily. Therefore, to realize positioning with Zigbee, special mobile terminal equipment is needed. Because of its very high cost, the Zigbee positioning mode is not applicable for people's daily use.

The existing location-based information services cannot meet people's demands for quick and accurate positioning. Therefore, the existing technologies need further improvement.

### SUMMARY OF THE INVENTION

The technical problem to be solved by this invention is, aiming at the deficiencies of the existing technologies, to provide with a system and method for indoor positioning/locating of a mobile terminal, which can position quickly, accurately, and simply, facilitating the use of people.

To solve the technical problems set forth above, this invention adopts the following technical solutions:

This invention discloses a system for indoor positioning of a mobile terminal. The system includes a control end, and at least one positioning node that is installed indoors. Among them, the at least one positioning node is used, under the control of the control end, to transmit linkage information to the mobile terminal within a specific zone, to receive response information responded by the mobile terminal, to measure signal strength of the response information, and to transmit the response information and signal strength information to the control end. The control end is used to analyze and calculate on the received response information and signal strength information, thereby locating the mobile terminal.

In a further embodiment, in the disclosed system for indoor positioning of a mobile terminal, the control end includes a back end and at least one control node connected with the back end. The at least one control node is used to control at least one positioning node to transmit linkage information to a mobile terminal and to transmit to the back end the received response and signal strength information along with the positioning node's identification-number information that is stored at the at least one control node itself. The back end is used to analyze and calculate on the response information and signal strength information.

In another embodiment, in the disclosed system for indoor positioning of a mobile terminal, the mobile terminal is equipped with a 2.4 GHz RF IC card.

In a yet further embodiment, in the disclosed system for indoor positioning of a mobile terminal, the at least one positioning node includes an RF interface device, an amplifying circuit, and a RF transceiver antenna, which are connected sequentially. The RF interface device is connected with at least one control node through a wired connection. The RF transceiver antenna is connected with the mobile terminal through a wireless connection and is used to transmit the linkage information and to receive the response information.

In yet another embodiment, in the disclosed system for indoor positioning of a mobile terminal, the frequency band of the RF interface device and that of the RF transceiver antenna are both 2.4 GHz.

In a further embodiment, in the disclosed system for indoor positioning of a mobile terminal, the at least one control node includes a microcontroller and a multi-way connector connected with the microcontroller. The microcontroller, via the multi-way connector, is connected with at least one positioning node through a wired connection, and controls the at least one positioning node to transmit to the mobile terminal linkage information as well as transmit power of the linkage information and to return to the back end response information, signal strength information, and the positioning node's identification-number information.

In yet another embodiment, in the disclosed system for indoor positioning of a mobile terminal, the back end is connected with at least one control node via a bus connection.

In a further embodiment, in the disclosed system for indoor positioning of a mobile terminal, the back end analyzes and calculates on at least the response information and signal strength information returned from two or more positioning nodes to realize accurate positioning of the mobile terminal. The specific process includes:

The back end takes or teats a first positioning node returning response information as an original positioning node. And, in accordance with the original positioning node's record information stored at the back end itself, the back end finds peripheral positioning nodes of the original positioning node.

The back end, through the control node, controls the peripheral positioning nodes to transmit linkage information to the mobile terminal respectively and to receive response information and signal strength information returned by the peripheral positioning nodes.

The back end, based on the response information and signal strength information returned by the original positioning node and peripheral positioning nodes, performs comprehensive analysis and calculations to realize accurate positioning of the mobile terminal.

Meanwhile, this invention also discloses a method for indoor positioning of a mobile terminal. The method comprises the following steps:

A control end controls at least one positioning node to transmit linkage information to a mobile terminal within a specific zone. And the control end also receives response information, which is responded by the mobile terminal and received by the at least one positioning node, as well as the response information's signal strength information measured by the at least one positioning node.

The control end analyzes and calculates on the response information and signal strength information to locating the mobile terminal.

In a further embodiment, in the disclosed system for indoor positioning of a mobile terminal, the control end includes a back end and at least one control node connected with the back end. The mobile terminal is equipped with a 2.4 GHz RF IC card.

Under the control of the at least one control node, at least one positioning node transmits linkage information to the mobile terminal equipped with a RF IC card.

The at least one positioning node receives response information responded by the mobile terminal and measures signal strength of the response information.

The at least one control node receives the response information and signal strength information transmitted by the at least one positioning node, and transmits to the back end the received response and strength information along with the positioning node's identification-number information stored by the control node.

The back end analyzes and calculates on the received response and signal strength information to locate the mobile terminal.

Because of the adoption of the technical solutions disclosed above, this invention has the following beneficial effects: in the disclosed systematic design, at least one positioning node, under the control of a control end, transmits linkage information to a mobile terminal within a specific zone, and receives response information responded by the mobile terminal, measures a signal strength of the response information, and transmits the response information and signal strength information to the control end. Moreover, the control end analyzes and calculates on the received response information and signal strength information so that accurate positioning of an indoor mobile terminal is realized, without a need to change existing mobile terminals. The disclosed positioning system and method herein is simple and convenient for use, and has extensive applicability.

### BRIEF DESCRIPTION OF THE DRAWINGS

FIG. 1 is an exemplary systematic diagram in accordance with an embodiment of this invention;

FIG. 2 is an exemplary schematic diagram illustrating a positioning node in accordance with an embodiment of this invention;

FIG. 3 is an exemplary schematic diagram illustrating a control node in accordance with an embodiment of this invention;

FIG. 4 is an exemplary diagram illustrating comprehensive measurement of multiple positioning nodes in accordance with an embodiment of this invention.

### DESCRIPTION OF THE EMBODIMENTS

Further detailed descriptions of this invention are given as follows through specific embodiments in combination with the attached figures. The examples proposed are used only for explaining this invention instead of limiting the scope of this invention.

Aiming at problems with existing positioning technologies that the positioning accuracy decreases abruptly when positioning a mobile terminal indoors or in a relatively enclosed environment, this invention proposes a system and method for indoor positioning/locating of a mobile terminal.

The concept of this invention is as follows: Through a systematic design, in which a specific positioning node communicates wirelessly with a mobile terminal located in a certain zone (e.g., indoor, a relatively enclosed environment, or an environment with a dense population), especially with one equipped with a 2.4 G RF IC card device, and the positioning node communicates with a control end, thereby enabling the positioning node to receive, within a certain range, response information responded by the mobile terminal. And this range can preliminarily meet the requirements of a minimum positioning accuracy. Further, when installing the positioning node, it is ensured that interference on its coverage range from various external objects is little. Accordingly, the accuracy of a signal strength obtained is also high. Therefore, the control end can locate the mobile terminal based on more accurate signal strength, thereby improving the accuracy of positioning an indoor mobile terminal. Moreover, because the mobile terminal equipped with a 2.4 G RF IC card can be widely used in people's daily lives, a positioning system based on such a mobile terminal can provide the LBS service very conveniently.

The disclosed system for indoor positioning of a mobile terminal, includes a control end and at least one positioning node installed indoors. The at least one positioning node is used, under the control of the control end, to transmit linkage information to a mobile terminal within a specific zone, to receive response information responded by the mobile terminal, to measure signal strength of the response information, and to transmit the received response information and signal strength information to the control end. The control end is used to analyze and calculate on the received response and signal strength information to locate the mobile terminal.

It shall be noted that the disclosed system for indoor positioning of a mobile terminal can be used in an indoor environments such as a large shopping mall and an entertainment place. However, it shall not be understood that this system can only be used in an indoor environment; instead, it can also be used in other relatively enclosed environments such as an underground parking lot, a channel, or other environments with a dense population, provided that positioning nodes can be fixedly installed in such a relatively enclosed environment.

A second point to be noted is that such a positioning node only transmits linkage information within a specific zone and the range of this specific zone is very small. That is, the coverage range of the linkage information transmitted by such a positioning node is very limited, normally around 20 meters. Therefore, if a mobile terminal can receive the linkage information transmitted by this positioning node, it means that the distance between the mobile terminal and this positioning node is very short. And thus, it can preliminarily meet requirements for a minimum positioning accuracy. However, as for the existing GSM base-station positioning or GPS positioning, positioning errors are normally tens or hundreds of meters. Considering the influence of the weather or building structures, the positioning accuracy will be even lower. But when positioning an indoor mobile terminal using the method disclosed in this invention, since the coverage range of each positioning node is small, signal strength information measured by the positioning node is more accurate. And thus, the control end can locate the indoor mobile terminal based on the more accurate signal strength information, thereby rendering the positioning accuracy of this disclosed positioning method higher than that of the GSM positioning mode and GPS positioning mode.

In a further embodiment, the control end specifically includes a back end and at least one control node connected with the back end. The at least one control node is connected with at least one positioning node, and is used to control the at least one positioning node to transmit linkage information to a mobile terminal and to transmit to the back end received response information and signal strength information along with the at least one positioning node's identification-number information stored by the at least one control node itself. The back end is mainly used to analyze and calculate on the received response information and signal strength information of the response information and locate the mobile terminal. Actually, the back end can be software running on a computer or system-record information for storing distribution positions of various control nodes. The back end is connected with at least one control node via a bus connection. It also utilizes certain software algorithms to analyze and calculate on the response information and signal strength information fed back by the at least one control node, thereby locating the mobile terminal. Of course, the back end can be connected with multiple control nodes, thereby analyzing and calculating on the response information and signal strength information fed back by multiple control nodes and then accurately positioning different mobile terminals.

In another embodiment of this invention, the mobile terminal is a mobile terminal equipped with a 2.4 GHz RF IC card. Such selection is mainly because such mobile terminal can communicate within a short distance, has a mobile payment function (e.g., an electronic wallet), and will surely obtain extensive applications in people's daily lives. Since the frequency band of the existing RF IC cards is based on 2.4 GHz, therefore, an RF IC card with a frequency band of 2.4 GHz can be selected here. With a mobile terminal equipped with a 2.4 GHz RF IC card, wireless communications between the mobile terminal and a positioning node at a short distance can be realized, thereby realizing accurate positioning of the mobile terminal. Therefore, accurate indoor positioning of such mobile terminal can be realized, without changing existing mobile terminals equipped with 2.4 GHz RF IC cards. Moreover, the disclosed positioning mode is simple and convenient for people's use.

In yet further embodiment of this invention, the at least one positioning node includes an RF interface device, an amplifying circuit, and an RF transceiver antenna, which are connected sequentially. The RF interface device is connected with at least one control node through a wired connection, and is used to receive a control command given by the at least one control node and to transmit response information and signal strength information to the at least one control node, thereby ensuring normal data/information exchanges between the at least one positioning node and the at least one control node. The RF transceiver antenna is connected with the mobile terminal through a wireless connection and is used to transmit linkage information and to receive response information returned by the mobile terminal. Because the frequency band of the RF IC card in the mobile terminal is 2.4 GHz, the frequency band of the RF transceiver antenna is also selected as 2.4 GHz. Because, only in this way, the normal mobile communication between the at least one positioning node and the mobile terminal at a short distance can be ensured. A frequency band of the RF interface device is also selected as 2.4 GHz. Only in this way, the normal communication between the at least one positioning node and the at least one control node can be ensured.

In a practical application, the at least one positioning node is installed fixedly at a specific indoor location, ensuring that the interference on its coverage range from various external objects is very limited. Moreover, a communication distance of the short-distance communication between the at least one positioning node and the mobile terminal equipped with 2.4 GHz RF IC card is within a certain radius range, with the at least one positioning node as the center. Normally, this certain radius range is called a coverage range of the at least one positioning node. As long as the mobile terminal is within the coverage range of the at least one positioning node, it can communicate with the at least one positioning node wirelessly. Usually, the radius of the coverage range of the at least one positioning node is less than 20 meters.

The at least one positioning node, under the control of at least one control node, broadcasts within its coverage range linkage information at all frequency points of the 2.4 GHz frequency point sequences. An RF IC card in the mobile terminal is located at one of the 2.4 GHz frequency point sequences. If the mobile terminal is located within the coverage range of this at least one positioning node, it can receive linkage information transmitted by the at least one positioning node and can return response information. If the mobile terminal is beyond the coverage range of the at least one positioning node, it cannot receive the linkage information. As long as the at least one positioning node and the mobile terminal are connected successfully, the back end can, through calculations, obtain the positioning information of the mobile terminal. Because the coverage range of the at least one positioning node is small and the interference on the at least one positioning node's coverage range from various external objects is very limited, the accuracy of the response information, which is responded by the mobile terminal and received by the at least one positioning node, is high. Compared with existing positioning technologies, the adoption of this disclosed method for indoor positioning of a mobile terminal not only can improve the positioning accuracy but also can ensure the extensive applicability of this positioning method.

Moreover, a wired connection mode is adopted between the RF interface device and the at least one control node. In this way, the response information and signal strength information received by the at least one control node is hardly influenced by the external environment and can be transmitted successfully to the back end for corresponding treatment, thereby ensuring the normal operation of the system. Of course, a wireless connection can be adopted between the RF interface device and the at least one control node.

In another embodiment of this invention, the at least one control node includes a microcontroller MCU and a multi-way connector connected with the microcontroller. The microcontroller, through the multi-way connector, is connected with at least one positioning node through a wired connection, specifically with an RF interface device in the at least one positioning node. The microcontroller is mainly used to control the at least one positioning node to transmit to the mobile terminal linkage information as well as the transmit power of the linkage information, and to return to the back end response information and signal strength information responded by the at least one positioning node.

It shows that whether a positioning node transmits linkage information to a mobile terminal or not is determined by a control node. Moreover, transmit power of the linkage information transmitted by the positioning node to the mobile terminal is also determined by the control node. The control node can enlarge or reduce the coverage zone of the positioning node by regulating the transmit power of the linkage information transmitted by the positioning node, thereby flexibly adjusting the accuracy of positioning the mobile terminal to a certain extent.

In a yet further embodiment of this invention, the back end at least analyzes and calculates on response information returned from two or more positioning nodes to realize accurate positioning of a mobile terminal. The specific process includes:

The back end takes or treats a first positioning node that returns response information as an original positioning node, and takes or treats a position of a mobile terminal determined by the original positioning node as an initial positioning position. Based on the original positioning node's record information stored at the back end itself, the back end finds peripheral positioning nodes of the original positioning node. When searching for the peripheral positioning nodes, the back end at least finds one or more peripheral positioning nodes. The back end, through at least one control node, controls the peripheral positioning nodes to transmit linkage information to the mobile terminal respectively and to receive response information returned by the peripheral positioning nodes. Finally, the back end, based on the response information and signal strength information returned by the original positioning node and peripheral positioning nodes, performs comprehensive calculations to realize accurate positioning of the mobile terminal.

That is to say, the back end firstly analyzes and calculates on response information returned by an original positioning node to determine an initial positioning position of a mobile terminal. Then, it analyzes and calculates on response information returned by a peripheral positioning node of the original positioning node, and comprehensively compares a distance between the original positioning node and the mobile terminal with a distance between the peripheral positioning node and the mobile terminal, thereby determining a final positioning location of the mobile terminal. Through this comprehensive measurement of multiple positioning nodes, the positioning accuracy can be improved, thereby realizing more accurate positioning of a mobile terminal and satisfying the people's demand for positioning accuracy.

It should be noted that, when the control node controls peripheral positioning nodes to transmit linkage information to a mobile terminal respectively, the peripheral positioning nodes do not need to transmit linkage information in all frequency point sequences of 2.4 GHz. Instead, they need only to transmit the information at a channel address of a 2.4 G frequency point sequence, which is generated from response information responded by the mobile terminal (to the original positioning node) that has been successfully connected with the original positioning node.

### EMBODIMENTS

The system for indoor positioning/locating of a mobile terminal is described in detail as follows:

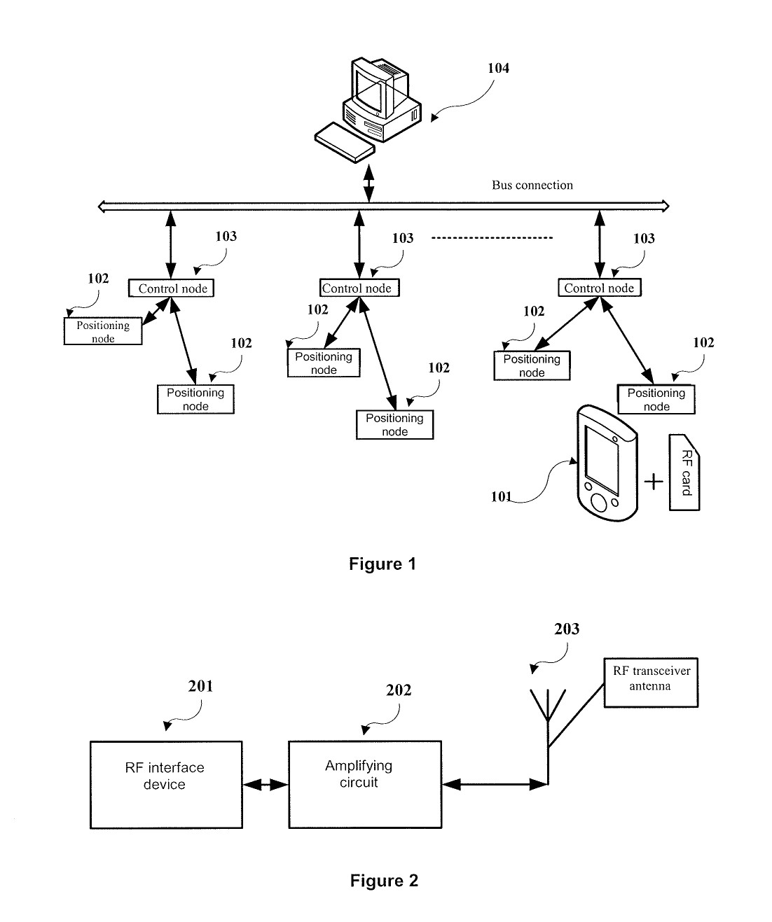

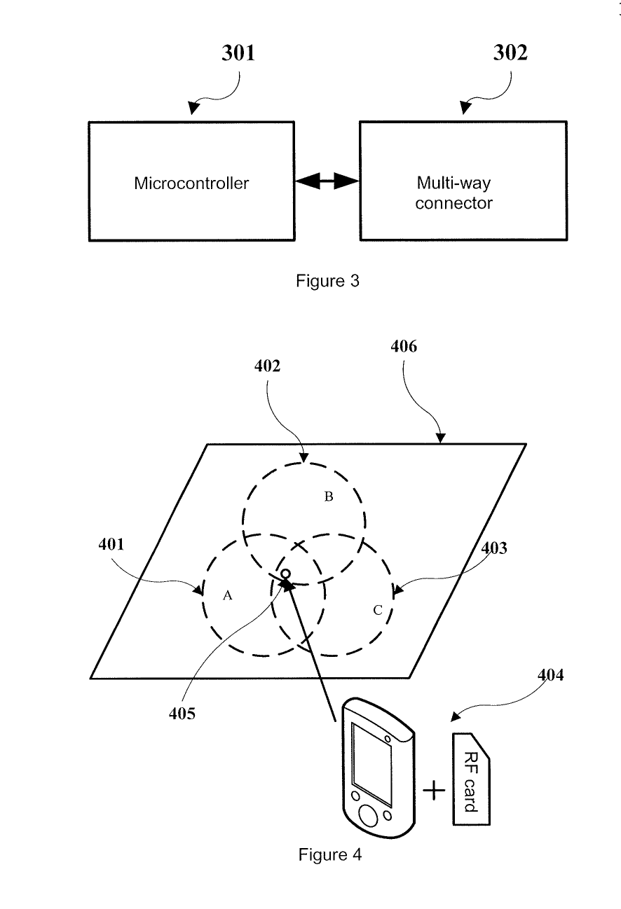

As shown in FIGS. 1-3, the system for indoor positioning of a mobile terminal can be applied to a mobile terminal with a 2.4 G RF IC card. Such positioning system comprises: a mobile terminal 101, one or more positioning nodes 102's, one or more control nodes 103's, and a back end system 104. Mobile terminal 101 can be a mobile terminal equipped with a 2.4 G RF IC card device. As shown in FIG. 2, positioning node 102 comprises an RF interface device 201 working in a 2.4 G frequency band, a signal amplifying circuit 202, and a 2.4 G RF transceiver antenna 203. Positioning node 102 is connected with control node 103 in a wired connection mode, and receives a control command of control node 103 and feeds data/information back. As shown in FIG. 3, control node 103 comprises a microcontroller MCU 301 and a multi-way connector 302. The control node can be connected with one or more positioning nodes through multi-way connector 302. Back end system 104 can be software operating on a general-purpose computer or system-record information for storing distribution positions of various control nodes.

FIG. 4 is an exemplary diagram illustrating comprehensive measurement of multiple positioning nodes in accordance with an embodiment of this invention. A workflow of the disclosed system for indoor positioning of a mobile terminal is described in detail as follows in combination with FIG. 4. As shown in FIG. 4:

S1. A mobile terminal 404 equipped with a 2.4 G RF IC card is located within an indoor motion plane 406, and enters a certain position 405 in a coverage area 402 of a positioning node A.

S2. Mobile terminal 404 is located at a certain random frequency point of 2.4 G frequency point sequences. A control node 103 controls a positioning node A to transmit linkage information on all frequency points of the 2.4 G frequency point sequences.

S3. Mobile terminal 404 responds to the linkage information transmitted by the positioning node A, and returns corresponding response information. This response information comprises a unique identification number of the mobile terminal itself.

S4. The positioning node A receives the response information, measures signal strength of the response information, and returns the response information and signal strength information of the response information back to control node 103.

S5. Control node 103 feeds back to back end 104 an identification number of the positioning node A along with the received response information returned by the mobile terminal 404 and the signal strength information measured by the positioning node.

S6. Back end 104, based on the identification number of the positioning node A, determines that mobile terminal 404 is located within a range of 20 meters with an installation location of the positioning node A as a center, thereby realizing initial positioning of the target. Now the positioning node A is called an original positioning node.

S7. Back end 104 finds information about peripheral positioning nodes B and C of the original the positioning node A from record information stored by the back end itself.

S8. Under the control of control node 103 and at a channel address of the 2.4 G frequency point sequences, which is generated from the response information responded by the mobile terminal 404 (to the original positioning node) that has been connected successfully (to the original positioning node), the peripheral positioning nodes B and C transmit linkage information to mobile terminal 404 respectively and sequentially to realize a connection with mobile terminal 404, receive response information responded by mobile terminal 404, and measure signal strength of the response information.

S9. The peripheral positioning nodes B and C return the response information and the measured signal strength information back to a corresponding control node 103 in an upper layer.

S10. Each control nodes 103 feeds back to back end system 104 the received response information and signal strength information along with an identification number of a corresponding positioning node;

S11. Through a certain software algorithm, back end system 104 analyzes comprehensively connection status of the positioning nodes A, B, and C and the received signal strength information, and obtains comparison information of the distances between mobile terminal 404 and each of the positioning nodes A, B, and C.

Meanwhile, this invention also provides with a method for indoor positioning/locating of a mobile terminal. The method comprises the following steps:

Step 1: A control end controls at least one positioning node to transmit linkage information to a mobile terminal. It also receives response information, which is responded by the mobile terminal and has been received by the positioning node, as well as signal strength information of the response information, which is detected and measured by the at least one positioning node;

Step 2: The control end analyzes and calculates on the response information and signal strength information to locate the mobile terminal.

In this embodiment, the control end comprises a back end and at least one control node that is connected with the back end. The mobile terminal is equipped with a 2.4 GHz RF IC card.

Under the control of the at least one control node, at least one positioning node transmits linkage information to a mobile terminal equipped with an RF IC card. The at least one positioning node receives response information responded by the mobile terminal and measures signal strength of the response information. The at least one control node receives the response information and signal strength information transmitted by the at least one positioning node, and transmits to the back end the response and signal strength information along with the at least one positioning node's identification-number information stored by the at least one control node. The back end analyzes and calculates on the received response information and signal strength information to position/locate the mobile terminal.

In specific applications of the present invention, based on the fact that existing mobile terminals commonly used by the people are equipped with 2.4 GHz RF IC cards, under the control of a control end, accurate positioning of an indoor mobile terminal is realized by making use of a wireless communication between a specific positioning node and a mobile terminal in a specific zone. Also, the positioning is simple, and is convenient for people to use. Compared with the conventional GSM positioning mode and GPS positioning mode, the positioning modes disclosed in the present invention improve positioning accuracy of an indoor mobile terminal. Compared with the Zigbee positioning mode, the positioning modes disclosed in the present invention can position without need to change the existing mobile terminals, thereby reducing the positioning cost and having extensive applicability. The present invention is especially applicable to positioning of a mobile terminal indoors, in a relatively enclosed environment, or an environment with dense population.

The above contents are detailed descriptions of this invention in combination with specific embodiments. It shall not be considered that specific implementations of this invention are limited to those descriptions. A person of ordinary skill in the art, to which the present invention pertains, can make certain simple deductions or substitutions, without going beyond the spirit and principle of this invention. All of these shall also be considered within the protection scope of this invention.

What is claimed is:

1. A system for indoor positioning of a mobile terminal, comprising:
a control end; and
at least one positioning node installed indoors;
wherein:
the at least one positioning node, under control of the control end, transmits linkage information to the mobile terminal within a specific zone, receives response information responded by the mobile terminal, measures signal strength of the response information, and transmits the response information and the signal strength information to the control end; and
the control end locates the mobile terminal based on analyzing and calculating on the received response information and signal strength information.

2. The system of claim 1, wherein the control end comprises:
a back end; and
at least one control node connected with the back end;
wherein:
the at least one control node controls the at least one positioning node to transmit the linkage information to the mobile terminal, and transmits to the back end the received response information and signal strength information along with the at least one positioning node's identification-number information stored by the at least one control node; and
the back end analyzes and calculates on the received response information and signal strength information.

3. The system of claim 2, wherein the mobile terminal is equipped with a 2.4 GHz RF IC card.

4. The system of claim 2, wherein the at least one positioning node comprises:
an RF interface device;
an amplifying circuit; and
an RF transceiver antenna;
wherein:
the RF interface device, the amplifying circuit, and the RF transceiver antenna are connected sequentially;
the RF interface device is connected with the at least one control node through a wired connection; and
the RF transceiver antenna is connected with the mobile terminal through a wireless connection, transmits the linkage information, and receives the response information.

5. The system of claim 4, wherein a frequency band of the RF interface device and a frequency band of the RF transceiver antenna are both 2.4 GHz.

6. The system of claim 2, wherein the control node comprises:
a microcontroller; and
a multi-way connector connected with the microcontroller;
wherein the microcontroller, via the multi-way connector, is connected with the at least one positioning node through a wired connection, controls the at least one positioning node to transmit to the mobile terminal the linkage information and transmit power of the linkage information, and returns to the back end the received response and signal strength information and identification-number information of the at least one positioning node.

7. The system of any of claims 2-6, wherein the back end is connected with the at least one control node through a bus connection.

8. The system of any of claims 2-6, wherein the back end performs accurate positioning of the mobile terminal based on analyzing and calculating on response information and signal strength information returned from two or more positioning nodes, the accurate positioning comprises:
treating, by the back end, a first positioning node that returns response information as an original positioning node and finding peripheral positioning nodes of the original positioning node based on the original positioning node's record information that is stored at the back end itself;
controlling, by the back end through the control node, the peripheral positioning nodes to transmit linkage information to the mobile terminal respectively and to receive response information and signal strength information, which is returned by the peripheral positioning nodes;
performing, by the back end, accurate positioning of the mobile terminal based on analyzing and calculating on the response information and signal strength information, which is returned by the original positioning node and the peripheral positioning nodes.

9. A method for indoor positioning of a mobile terminal, comprising the following steps:
transmitting, by a control end through controlling at least one positioning node, linkage information to the mobile terminal within a specific zone;
receiving response information, which is responded by the mobile terminal and has been received by the at least one positioning node, as well as signal strength information of the response information, which has been measured by the at least one positioning node; and
locating, via the control end, the mobile terminal based on analyzing and calculating on the received response information and signal strength information.

10. The method of claim 9, wherein the control end comprises a back end and at least one control node connected with the back end and the mobile terminal is equipped with a 2.4 GHz RF IC card, the method further comprising:
transmitting, via the at least one positioning node under control of the at least one control node, linkage information to the mobile terminal;
receiving, via at least one positioning node, the response information responded by the mobile terminal and measuring the signal strength of the response information;
receiving, at the at least one control node, the response information and signal strength information transmitted by the at least one positioning node, and transmitting to the back end the response and signal strength information along with the at least one positioning node's identification-number information stored by the at least one control node; and
analyzing and calculating, via the back end, on the received response and signal strength information to locate the mobile terminal.
